(19) United States
(12) Patent Application Publication
(10) Pub. No.: US 2009/0044408 A1
(43) Pub. Date: Feb. 19, 2009

(54) Fin-Tube Heat Exchanger Collar, and Method of Making Same

(76) Inventor: John Lamkin, Grenada, MS (US)

Correspondence Address: BAKER, DONELSON, BEARMAN, CALDWELL & BERKOWITZ, PC, 900 SOUTH GAY STREET, 2200 RIVERVIEW TOWER, KNOXVILLE, TN, 37902, US

(21) Appl. No.: 12/257,865

(22) Filed: Oct. 24, 2008

Related U.S. Application Data
(63) Continuation-in-part of application No. 11/355,833, filed on Feb. 16, 2006, now abandoned.
(60) Provisional application No. 60/666,120, filed on Mar. 29, 2005.

(51) Int. Cl. B23P 15/26

(52) U.S. Cl. 29/890.046

(57) ABSTRACT

A method for forming collars in a thermally conductive plate is provided. The method includes the steps of placing a thermally conductive plate, or fin stock, within a press, and then advancing the plate through the press in order to draw a desired amount of ductile material from a plurality of collar locations within the plate. The ductile material is used in forming the collars. The method also includes further advancing the plate in order to pierce the material at the collar locations, thereby creating a plurality of through-openings in the plate. Each through-opening defines a radial wall having a proximal end and a distal end. The press is used to fold material at the distal end of the respective walls inwardly into substantial contact with an inner diameter of the walls. In this way, a plurality of collars having a first flare are formed. The material is further advanced through the press so that the distal ends of the collars are flared outwardly, thereby forming double flare collars. A reflare punch is used in forming the double flare collars at the plurality of collar locations.

### CROSS REFERENCE TO RELATED APPLICATIONS

The present application claims the benefit of U.S. patent application Ser. No. 11/355,833. That application was filed as a utility application on Feb. 16, 2006 and was entitled “Fin-Tube Heat Exchanger Collar, and Method of Making Same.”

The 2006 utility application claimed priority to Provisional Patent Application Ser. No. 60/666,120 filed Mar. 29, 2005. That application was also entitled “Fin-Tube Heat Exchanger Collar, and Method of Making Same.”

The 2006 utility application and the provisional application are each incorporated herein by reference in their entireties.

### STATEMENT REGARDING FEDERALLY SPONSORED RESEARCH OR DEVELOPMENT

Not applicable.

### INCORPORATION BY REFERENCE OF MATERIAL SUBMITTED ON COMPACT DISC

Not applicable.

### FIELD OF THE INVENTION

The present invention generally relates to the field of heating and air conditioning systems. More specifically, the present invention pertains to the assembly of a fin-tube heat exchanger in a heating or air conditioning system, and to improved thermal connection collars.

### BACKGROUND OF THE INVENTION

Heating, ventilation and air conditioning systems are commonly used to control indoor air temperature. In geographical areas experiencing hot or humid conditions, the circulation of refrigerated air through air ducts and into a home or office provides much needed comfort. In addition, the process of chilling circulated air results in the removal of a percentage of moisture suspended in the air. This, in turn, reduces the presence of mold and mildew in the indoor environment so as to improve occupants' health.

A conventional air conditioning system employs a refrigerant for chilling air. The refrigerant is a chemical that is easily converted from a gas to a liquid, and then back to a gas again. A common example is Freon™, which is an example of a nonflammable chlorofluorocarbon, or “CFC.” The chemical refrigerant may more generically be referred to as a “working fluid.”

To induce the cyclical phase change of the refrigerant, the refrigerant, or “working fluid,” is pumped from a compressor, through a condenser, to an evaporator, and then back to the compressor. When the working fluid leaves the condenser it is in a cooled liquid state. The refrigerant then moves through a series of tubes in the evaporator. The tubes act as a heat exchanger when air is moved across them and through the system.

The tubes are commonly fabricated from copper or a copper-based alloy due to its corrosion-resistant properties and favorable thermal conductivity. In some instances, the copper tubes are fabricated from copper deoxidized by phosphorous. The tubes may alternatively be fabricated from aluminum, stainless steel, carbon steel, or other thermally conductive metallic material. Regardless of material, the tubes define elongated tubular bodies, and may have an outer diameter of 5 mm, ¼″, 7 mm, 5/16″, ⅜″, ½″, ⅝″, 1″, or some size intermediate thereto.

Incorporated into the evaporator/condenser is a fan. When activated, the fan causes air to blow across the coils as it circulates air inside of a building. Movement of air across the coils causes the air to be chilled to a point near or below the dew point. Thus, the evaporator serves as a heat exchanger for cooling air by removing heat from the air.

In order to improve the efficiency of the evaporator/condenser, a plurality of fins may be mechanically connected to the tubes. The fin-and-tube arrangement forms what is known as a fin-tube heat exchanger. Connection of the fins to the tubes is made by first forming insert openings in the respective fins at corresponding coordinates in the fins. The tubes are then moved through the insert openings of adjacent fins. Thereafter, a bearing or “expansion tip” is urged through each of the tubes in order to expand the outer diameter of the tubing into frictional engagement with the surrounding fins.

As noted, a plurality of fins is provided in the evaporator. Commonly, a fin density of four to fourteen fins per inch is employed. The fins typically define planar aluminum or aluminum alloy plates, although copper fins may also be used. The fins are positioned in side-to-side, parallel relation to one another, with the insert openings being aligned to receive transverse tubes. Holes at different coordinates in the fins will receive different tubes so that a single fin may receive four to 20 or even more tubes, depending on the size of the evaporator.

When chilled refrigerant moves through the tubing, the tubing is itself chilled. This, in turn, causes the plurality of fins to likewise be cooled by thermal conduction. In operation, as air moves through the evaporator, it contacts not only the tubes, but also the numerous fins positioned transverse to the tubes. Because the fins have been cooled due to contact with the tubes, the fins substantially increase the cooled surface area across which air must pass as it flows through the evaporator. In this manner, the air is chilled in a more efficient manner.

During the formation of insert openings in fins, it is known to form raised openings known as collars. The collars are formed by urging a sheet of soft metal such as aluminum sequentially through a press having a die plate. The metal is pressed against bushings on the die plate and moved longitudinally. As the metal sheets are advanced, they are cut to the dimensions needed for a particular heat exchanger. The end result is a plurality of collars in an aluminum sheet, each of which defines an insert opening for receiving a tube. From there, the sheets of metal are placed in side-by-side relation. In this manner, multiple thin fins having insert openings with aligned collars are formed.

After the fins are positioned, the tubes are inserted through the respective aligned collars. In most instances, the collars also serve to provide equidistant spacing between fins. Thereafter, and as noted above, an expansion ball is urged along a length of each tube in order to radially expand the tubes. Expansion of a tube causes the tube to frictionally engage the surrounding collars.

It is desirable to outwardly “flare” the distal end of each collar. This aids in the insertion of the tubes through the various collars. Flaring also serves to maintain equidistant spacing between the adjacent fins. In this respect, the diameter of the flare will be greater than the diameter of the wall of the collar, thereby preventing adjacent collars from becoming stuck together. U.S. Pat. No. 6,513,587 entitled “Fin Collar and Method of Manufacturing” discloses various methods for creating the outward flare. The '587 patent is incorporated herein by reference in its entirety except to the extent it is inconsistent with the teachings herein.

It has been observed that the manufacturing process for forming outwardly flared collars may result in some splitting of the ductile metal material of the fins. This splitting will most typically occur along the distal end of the collar. The splitting of the collar will impede the mechanical bond between the collar and the received tube. Of even greater concern, a split collar is less efficient in transferring cool energy from the tube to the surrounding fin during operation.

Therefore, a need exists for an improved method of forming collars in evaporator/condenser fins. A need further exists for a collar having a greater amount of metal material. Still further, a need exists for a collar arrangement that has improved strength and thermal transfer efficiency towards its distal end.

### BRIEF SUMMARY OF THE INVENTION

A collar for a fin-tube heat exchanger is first provided. The collar defines a through-opening dimensioned to receive a tube carrying a working fluid. The collar extends outwardly from a thermally conductive plate. The plate serves as a fin for the fin-tube heat exchanger.

The collar generally includes a wall drawn from the thermally conductive plate. The wall has a proximal end integral to the plate and a distal end folded inwardly into contact with an inner diameter of the wall so as to form a first flare. Preferably, the wall is substantially circular in profile, though it may be oval.

In one aspect, the distal end has a greater outer diameter than an outer diameter of the proximal end. In this way, a second flare is provided. Thus, the collar is a “double” flare collar.

A fin for a fin-tube heat exchanger is also provided. The fin includes a thermally conductive plate. In addition, the fin includes a plurality of double flare collars within the plate. Each collar comprises a radial wall drawn from the plate and defining an opening dimensioned to receive a tube. Each wall also has a proximal end integral to the plate and a distal end folded inwardly into contact with an inner diameter of the wall so as to form a substantially solid first flare. The distal end of each respective wall is flared outwardly to provide a greater outer diameter than an outer diameter of the respective proximal ends of the walls, thereby forming a second flare. In this way, double flare collars are formed.

In addition, a fin-tube heat exchanger is offered. The exchanger includes at least one elongated tube received through through-openings in a plurality of thermally conductive parallel plates. The through-openings are formed from substantially cylindrical walls extending from each of the plates. Each wall defines a proximal end integral to the conductive plate, and a distal end forming an opening configured for receiving the tube. The distal end of each wall is folded inwardly into substantially continuous contact with an inner diameter of its respective wall so as to form a first flare at the distal end. In addition, each distal end may have a greater outer diameter than an inner diameter of its respective proximal ends. The result is that a plurality of double flare collars is formed in the plates.

In one aspect, each of the plates comprises a plurality of substantially cylindrical walls defining double flare collars for receiving a plurality of respective tubes. Further, each of the plates has correlating through-openings that are aligned.

A method for forming collars in a thermally conductive plate is also provided. In one embodiment, the method includes the steps of placing a thermally conductive plate within a press, and then advancing the plate through the press in order to draw a desired amount of ductile material from a plurality of collar locations within the plate. The ductile material is used in forming the collars. The method also includes further advancing the plate in order to pierce the material at the collar locations, thereby creating a plurality of through-openings in the plate. Each through-opening defines a radial wall having a proximal end and a distal end.

The method further includes the step of using the press so as to fold material at the distal end of the respective walls inwardly into contact with an inner diameter of the walls. In this way, a plurality of collars having a first flare are formed. Preferably, each of the walls has a substantially circular profile, although the profile may be oval or other shape.

In one aspect, the method includes still further advancing the plate through the press so as to expand the outer diameter of each of the walls at its distal end, thereby forming a second flare. In this manner, a plurality of double flare collars is formed. The method may then further include inserting a tube through at least one of the plurality of through-openings, and expanding the tube into frictional engagement with the respective surrounding walls.

It is noted that the method for forming collars in a thermally conductive plate involves a drawing process. In this respect, the metal material forming each collar is extruded, thinned and manipulated by a series of bushings and dies. The result is that the height of each collar is not limited by an initial punch creating an opening; rather, the material is manipulated to establish a desired collar height before a piercing stage takes place.

Finally, a method for forming a plurality of collars in a thermally conductive plate is disclosed. The method includes the steps of placing a thermally conductive plate within a press, and advancing the plate through the press in order to draw a desired amount of ductile material from a plurality of collar locations within the plate. The material is used in forming the collars.

The method also includes further advancing the plate in order to pierce the material at the collar locations. This creates a plurality of circular through-openings in the plate. Each through-opening defines a radial wall having a distal end dimensioned to receive a tube.

The method also includes using the press so as to form a first flare at the distal end of each of the respective walls. The distal end of each wall is folded inwardly into its respective wall. The method also includes further using the press so as to form an outward flare at the distal end of each of the plurality of walls such that the outer diameter of the distal end of each wall is expanded, thereby forming a plurality of double flare collars

In one aspect, the step of forming a plurality of through-openings in the plate comprises using a pierce punch to pierce through openings through the plate, each through-opening having a proximal end integral to the plate having a first diameter, and a distal end having a second smaller diameter. Further, the step of forming a first flare at the distal end of each of the plurality of walls may comprise moving a reflare punch down onto the distal end of each of the walls, the reflare punch having a tapered tip with a diameter that is larger than the second diameter of each of the walls, thereby forming an inward flare. Finally, the step of forming an outward flare at the distal end of each of the plurality of walls may comprise further moving the reflare punch downward onto the distal end of the walls so as to enlarge the second diameter.

### BRIEF DESCRIPTION OF THE DRAWINGS

So that the present invention can be better understood, certain drawings are appended hereto. It is to be noted, however, that the appended drawings illustrate only selected embodiments of the inventions and are therefore not to be considered limiting of scope, for the inventions may admit to other equally effective embodiments and applications.

FIG. 1 presents a cross-sectional view of a single collar for a fin-tube heat exchanger. This is a known single “reflare” design.

FIG. 1A shows a progression of steps for forming the single “reflare” collar of FIG. 1. The steps are shown through a side view of a plate.

FIG. 2 presents a cross-sectional view of a single collar for a fin-tube heat exchanger of the present invention, in one embodiment. This is referred to herein as a “double flare” design.

FIG. 2A shows a progression of steps for forming the “double flare” collar of FIG. 2, in one embodiment.

FIG. 2B is an enlarged view of the seventh stage from FIG. 2A. Here, a side wall and the double flare feature are more clearly seen.

FIGS. 3A-3C each show an enlarged cross-sectional view of selected steps from FIG. 1A. Tooling used for these prior art steps is also shown in cross-section.

FIG. 3A demonstrates a pierce step.

FIG. 3B shows an extrusion step.

FIG. 3C shows an outward “reflaring” step.

FIGS. 4A-4C each show an enlarged cross-sectional view of selected steps from FIG. 2A. Tooling used for the steps is also shown in cross-section.

FIG. 4A demonstrates a pierce step. This is the same step as FIG. 3A.

FIG. 4B shows a first flaring step. In this instance, the flaring is inward.

FIG. 4C shows a subsequent outward flaring step. A “double flare” collar is thus forward.

FIG. 5 is an enlarged, cross-sectional view of a processing step for forming the double flare collar of the present invention. This view shows a reflare punch being brought down upon a pierced collar to accomplish the steps of FIGS. 4B and 4C.

FIG. 6 presents a portion of a fin having a plurality of completed double flare collars. The double flare collars have a circular profile.

FIG. 7A presents a cross-sectional view of the collar of FIG. 2. In this view, a tube has been moved through the insert opening of the collar.

FIG. 7B presents a cross-sectional view of the collar of FIG. 7A. Here, the tube is being radially expanded along a portion of its length, including a portion adjacent the collar.

FIG. 8 is a cross-sectional view of a double flare collar of the present invention, in an alternate embodiment. Here, both flare steps provide an outward flare.

FIG. 9 is a perspective view of a portion of a fin-tube heat exchanger having a plurality of fins. Double flare collars receive tubes of the exchanger.

FIG. 10 presents a portion of a fin having a plurality of completed double flare collars. The double flare collars have an oval profile.

### DETAILED DESCRIPTION

### Definitions

As used herein, the term “fin-tube heat exchanger” means any heat exchanger that employs tubes for receiving a working fluid, and a plurality of adjacent plates that receive the plurality of tubes and which conduct thermal energy from the tubes for changing the temperature of air passed across the tubes and plates. The fin-tube heat exchanger may operate to add heat to circulated air, or to remove heat from circulated air.

The term “plate” refers to any substantially flat, thermally conductive object of any dimension. The term is intended to encompass not only sheets of material that are literally flat, but also sheets that have corrugated surfaces, sinusoidal profiles, serrated profiles, raised lance or other profiles designed to enhance heating or cooling efficiency as air is circulated across the plate.

The term “drawn” refers to a metal stamping process wherein a volume of metal material is taken from a metal plate, and manipulated and formed to create a select shape and height. The drawing process is accomplished by a series of bushings and dies.

### Description of Specific Embodiments

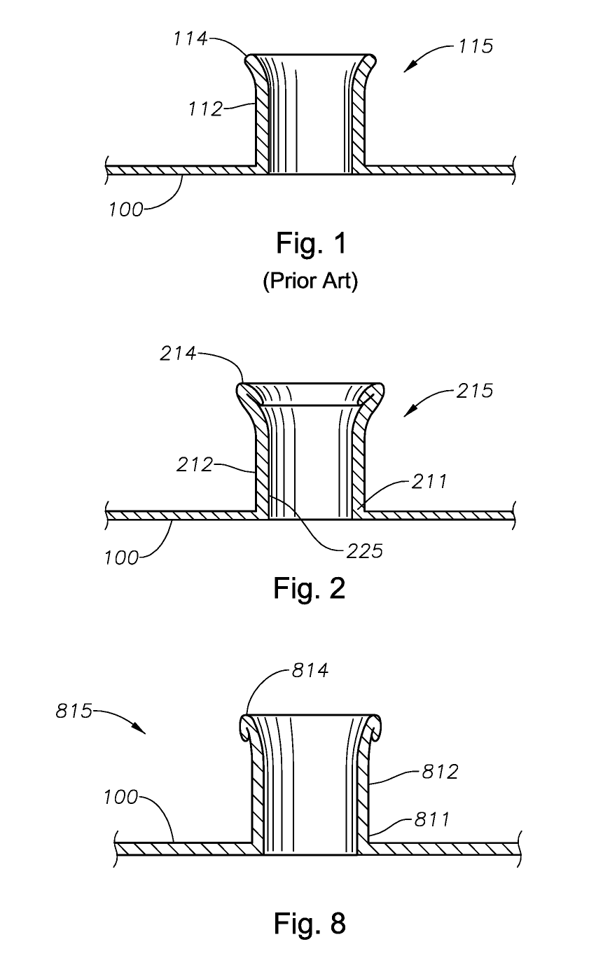

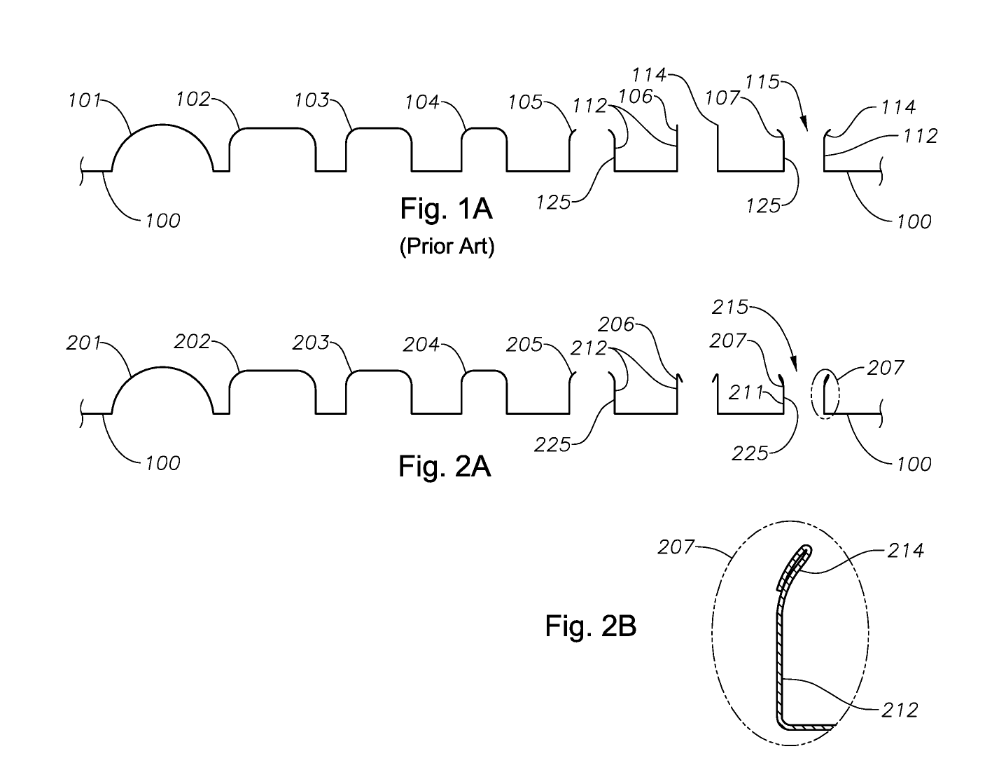

FIG. 1 presents a cross-sectional view of a single collar 115 for a fin-tube heat exchanger. This is a known collar design in common use today. The collar 115 is integral to fin stock, or a “plate.” The plate is partially seen at 100. A wall of the collar 115 is shown at 112. The wall 112 has been extruded from the plate 100 during a metal pressing process. The wall 112 may be either circular or oval in shape. A distal end of the collar 115 is seen at 114.

It is seen from the prior art collar 115 that the distal end 114 is flared outwardly. This flaring is known in the metal tooling industry as a “reflare.” This is something of a misnomer, as the distal flaring is really the first and only flaring imposed upon the wall 112 of the collar 115. (Earlier stages for forming the wall 112 are actually draw stages, not flaring steps.) Therefore, this flare feature is referred to herein as a single “flare.”

FIG. 1A shows a progression of steps for forming the single flare collar 115 of FIG. 1. The steps are schematically shown through a side view of the plate 100. The metal plate 100 is taken through a series of stages, culminating in the forming of the collar 115. It is understood that each of these stages is performed using a metal stamping machine (not shown) having selectively formed bushings (also not shown) above and/or below the metal plate 100 in order to form the collars 115. It is also understood that in actual practice, the plate 100 will be pressed into a fin having a plurality of collars 115 as the plate is progressively moved through the metal stamping machine. About two to twenty stamping steps may be provided in order to form collars 115 in plate 100.

A first stage 101 is a draw stage. Here, a hemisphere-profile or “bubble” is formed in the fin stock 100. No through-opening is yet formed.

A second stage 102 is also a draw stage. Here, the profile of the pre-formed collar is flattened at the top.

A third 103 and a fourth 104 stage are also each draw stages. In these stages, the width of the flattened profile is progressively reduced. In this manner, the collar is being formed to the desired height and width. It will be understood by those of ordinary skill in the art that intermediate draw stages before and between the third 103 and fourth 104 stages may be employed.

A fifth representative stage 105 is a piercing stage. Side walls 112 and a through-opening 125 are now formed. It is understood that the through-opening 125 is radial, i.e., circular or oval, meaning that the opposing side walls 112 are actually one continuous wall. It is again noted that the fifth stage 105 is representative of a piercing stage, and is not necessarily the numerically fifth stage in the metal stamping process. More than four previous stages may be applied.

In a sixth stage 106, the side walls 112 are extruded or extended upwards away from the plate 100. The side wall 112 has a distal end 114 away from the fin stock 100. It is noted that the fifth stage 105 and the sixth stage 106 are demonstrated as separate steps. However, it is possible to combine these stages 105, 106 in a single stamping process.

Finally, a seventh stage 107 is a flare stage. In this stage, the distal end 114 of the wall 112 is flared outwardly to form a single flare. The result is that the distal end 114 has a larger diameter than the rest of the wall 112. Distal end 114 of FIG. 1A corresponds to distal end 114 of FIG. 1.

It is again noted that the various stages 101, 102, 103, 104, 105, 106, 107 are representative, and are not intended to be exclusive. Thus, additional metal forming stages may and most likely are utilized during the metal stamping process to form the most thermally efficient collar 115.

The collar 115 of FIG. 1 and FIG. 1A has a disadvantage in that the flared distal end 114 may crack or split during the fabrication process. Splitting may occur, for example, during the flaring step 107. Expansion of a tube received within the through-opening 125 of the collar 115 may cause further cracking and splitting of the collar 115. Cracking reduces the bond between the tube and the surrounding collar 115, that is, the collar formed from the process of FIG. 1A. Cracking also decreases thermal conduction into the collar 115 and the surrounding fin formed from plate 100. Therefore, a need exists for an improved collar design that is resistant to cracking.

FIG. 2 presents a cross-sectional view of a single collar 215 for a fin-tube heat exchanger of the present invention, in one embodiment. This is referred to herein as a “double flare” design. As with the collar 115 of FIG. 1, the collar 215 of FIG. 2 is formed from and is integral with a fin stock, or “plate.” The plate is partially seen at 100. A wall of the collar 215 is shown at 212. The wall 212 has been drawn from the plate 100 during a metal pressing process. The wall 212 may be either circular or oval in shape. The wall 212 has a proximal end 211 integral to the plate 100, and a distal end 214 defining a through-opening 225.

It is seen from FIG. 2 that the distal end 214 of the collar 215 is again flared outwardly. However, it is also flared inwardly by folding over the distal end 214 into the inner diameter of the wall 212. In this way, a “double flare” is uniquely formed. It is anticipated that the double flare feature will be less much susceptible to cracking as compared to collar 115 of the prior art.

FIG. 2A shows a progression of steps for forming the “double flare” collar 215 of FIG. 2, in one embodiment. A series of stages is again shown for forming collars in the plate 100. The plate 100 is taken through the series of stages, culminating in the forming of a collar 215. Collar 215 correlates to collar 215 of FIG. 2. It is again understood that each of these stages is performed using a metal stamping machine (not shown) having selectively formed bushings (also not shown) above and/or below the fin stock 100 in order to form collars. It is also understood that the stages are depicted through a cross-sectional cut of the plate 100.

A first stage 201 is a draw stage. Stage 201 defines the formation of a hemisphere- profile in the plate or fin stock 100. To form the hemisphere, the plate is stamped using a hemisphere-shaped punch. However, the plate 100 is not pierced.

A second stage 202 is likewise a draw stage. Here, the pre-formed collar is flattened at the top. This stage 202 is formed using one or more presses that produce a more rectangular profile.

A third 203 and a fourth stage 204 each demonstrate that the width of the flattened profile in the pre-formed collar is progressively reduced. These stages 202 are formed using presses that produce a more squared profile.

A fifth stage 205 is a piercing stage. A side wall 220 and a through-opening 225 are now formed. The through-opening 225 is preferably circular.

A sixth stage 206 shows that the side wall 212 is “flared” downwardly.

Finally, a seventh stage 207 demonstrates that the distal end of the flared side wall 212 is flared outwardly. In this way, a “double flare” is formed at the distal end 214 of the collar 215. Distal end 214 of FIG. 2A corresponds to distal end 214 of FIG. 2.

Stages 206 and 207 may and preferably are combined into a single step during the collar-forming process. Either way, the end result is that the double flared distal end 214 has a larger outer diameter than the outer diameter of side wall 212 at its proximal end 211, while having a greater thickness than the single flared distal end 114 of the collar 115 of FIG. 1.

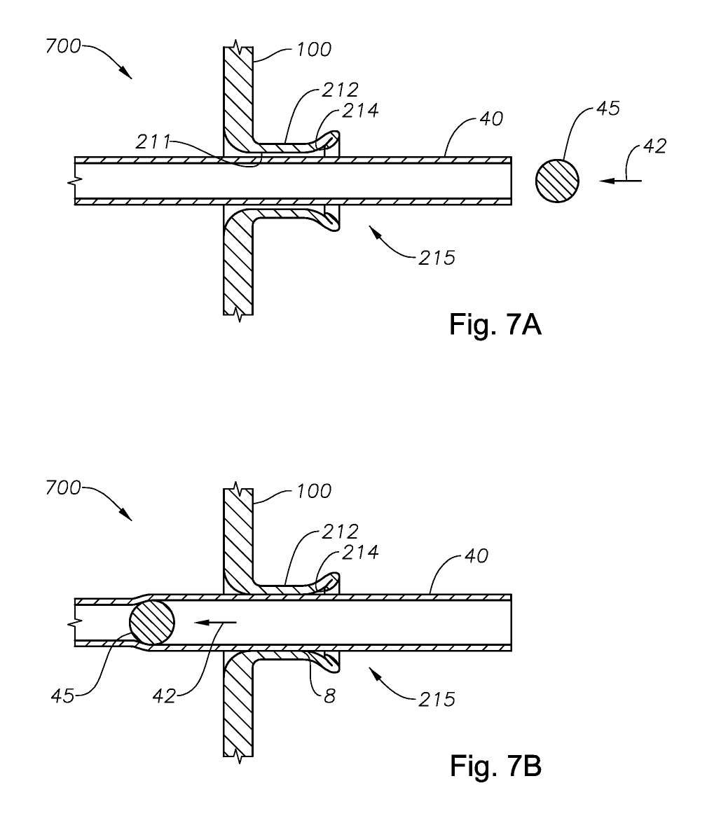

FIG. 2B is an enlarged view of the seventh stage 207 from FIG. 2A. Here, a side wall 212 and the double flared distal end 214 are more clearly seen. The distal end 214 is folded inwardly to form a substantially continuous double flared wall. It is believed that the double flared distal end 214 will help protect against cracking during a subsequent expansion process (shown in FIGS. 7A and 7B).

It is understood that the various stages 201, 202, 203, 204, 205, 206, and 207 are representative, and are not intended to be exclusive of all steps that might be employed in a collar-forming process. Additional metal forming stages may be utilized during the metal stamping process to form a thermally efficient collar 215. In any instance, the process for forming collars in a thermally conductive plate involves a drawing process. In this respect, the metal material forming each collar is extruded and manipulated by a series of bushings and dies, as indicated in representative stages 201-204. The result is that the height of each collar 215 is not limited by an initial punch creating an opening; rather, the material is manipulated to establish a desired collar height before the piercing stage 205 takes place.

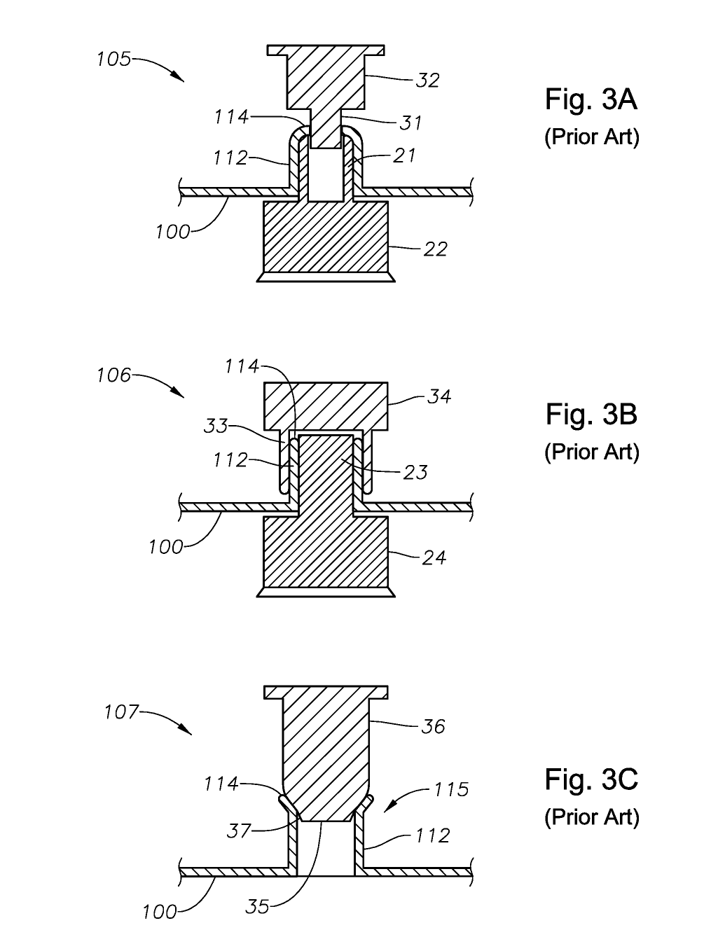

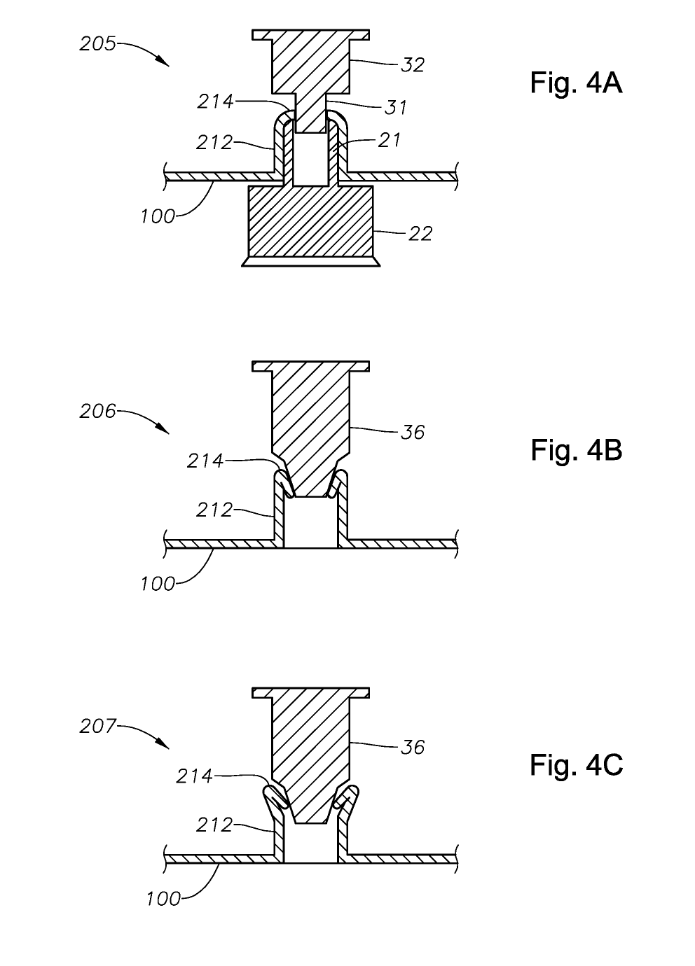

As noted, metal pressing processes are employed in order to form the collars 115 and 215. In connection with this process, selected tools are again used on opposing sides of the plate 100. These tools include various configurations of bushings, punches and dies. FIGS. 3A-3C and 4A-4C are offered to show certain stages in the collar formation processes of FIGS. 1A and 2A, respectively.

FIGS. 3A-3C show enlarged, cross-sectional views of selected steps from FIG. 1A. Tooling used for the selected prior art stages is also shown in cross-section.

FIG. 3A demonstrates the pierce step 105. To effectuate the pierce, a pierce punch 32 is provided. The pierce punch 32 includes a tip 31 that contacts the distal end 114 of the metallic material used in forming the collar 115. The tip 31 extends through the distal end 114 of the radial wall 112. The plate 100 and protruding radial wall 112 are supported from below by a pierce die 22. The pierce die 22 includes a bushing end 21 that extends upwards into the inner diameter of the wall 112. The bushing end 21 may receive the tip 31 of the pierce punch 32 during the piercing step 105.

FIG. 3B shows the extrusion step 106. An extrude punch 24 is placed below the fin stock 100. The extrude punch 24 includes a punch tip 23 that is pushed upwards into the inner diameter of the wall 112 of the plate 100. As the punch tip 23 contacts the distal end 114 of the stock 100, the distal end 114 is straightened so that the wall 112 now takes on a cylindrical shape. An extrude bushing 34 is typically placed above the wall 112. The extrude bushing 34 includes a bushing end 33 having an inner diameter that is received over the cylindrical wall 112 to maintain radial uniformity.

It is possible to combine the pierce step 105 and the extrusion step 106. To do this, the bushing end 21 of the pierce die 22 is pushed upwards through the distal end 114 of the wall 112 as the tip 31 of the pierce punch 33 moves downward through the distal end 114. At the same time, the tip 33 of the extrude bushing 34 is moved downward over the outer diameter of the wall 112. The bushing end 21 is modified to be longer so as to effectuate the straightening of the wall 112 seen in stage 106.

FIG. 3C shows the outward flaring step 107. To accomplish the flaring step 107, a reflare punch 36 is employed. The reflare punch 36 is brought down into the inner diameter of the wall 112. The reflare punch 36 defines a body having a distal tip 35. The diameter of the tip 35 is smaller than the inner diameter of the wall 112. It also has a tapered edge 37 which increases in diameter away from the tip 35. As the reflare punch 36 is pushed into the inner diameter of the wall 112, the tapered edge 37 contacts the distal end 114 of the wall 112, causing the distal end 114 to flare outwardly. The result is that the distal end 114 has an outer diameter larger than the outer diameter of the wall 112 proximate the fin stock 100. This in turn produces a single flare collar 115.

FIGS. 4A-4C show enlarged, cross-sectional views of selected steps from FIG. 2A. Tooling used for the selected stages is also shown in cross-section.

FIG. 4A demonstrates the pierce step 205. To effectuate the pierce, a pierce punch 32 is provided. This may be the same punch 32 as was used in the pierce step 105 of FIG. 3A. The pierce punch 32 again includes a tip 31 that contacts the distal end 214 of the metallic material 100 used in forming the collar 215. The tip 31 extends through the distal end 214 of the fin stock 100 and into the radial wall 212. The plate 100 and protruding radial wall 212 are supported from below by a pierce die 22 with a bushing end 21 that extends upwards into the inner diameter of the wall 212. Thus, step 205 may be the same as step 105 shown in FIG. 3A.

FIG. 4B shows a flaring step 206. The flaring step 206 uses a reflare punch such as punch 36. As noted above, the reflare punch 36 defines a body having a distal tip 35. The diameter of the tip 35 is smaller than the inner diameter of the wall 212. At the same time, it has a diameter that is larger than the inner diameter of the distal end 214 of the wall 212 from step 205. This permits the tip 35 of the reflare punch 36 to catch the curved distal end 214 of the wall 212 when it is brought down into contact with the distal end 214.

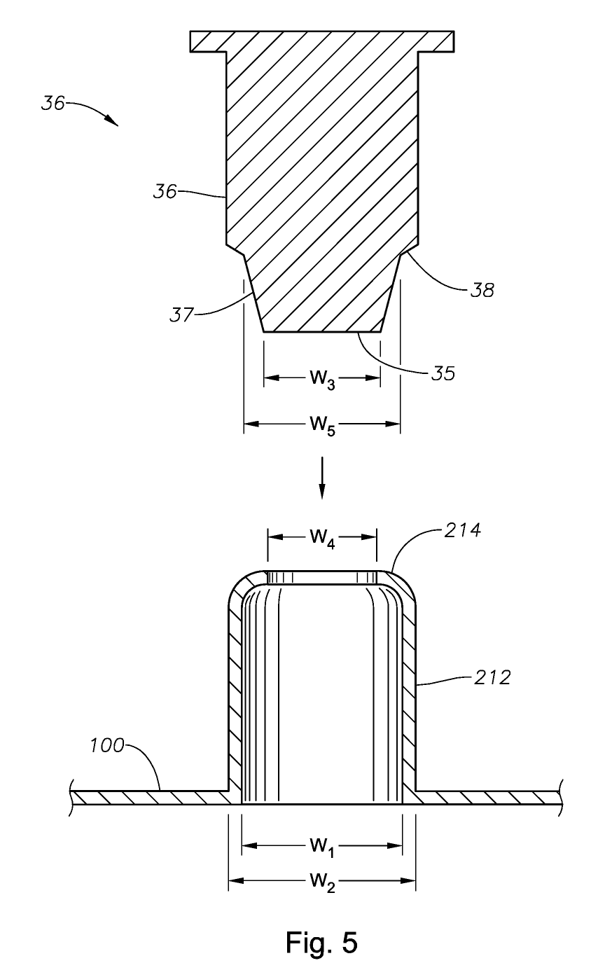

FIG. 5 presents an enlarged, cross-sectional view of a processing step for forming the double flare collar 215 of the present invention. This view shows the reflare punch 36 being brought down upon the drawn collar in accordance with step 206 of FIG. 4B. In this view, the punch 36 has not yet contacted the distal end 214 of the wall 212.

Various diameters are indicated in FIG. 5. These are noted as w₁, w₂, w₃, w₄ and w₅. The diameters w₁ and w₂ represent the inside and outside diameters of the wall 212, respectively. In one collar 215 arrangement, w₁ is about 0.385″, while W2 is about 0.395″. This will leave about a 0.005″ wall thickness on each side. The diameter w₃ represents the diameter of the tip 35 at the lower end of the taper 37, while diameter w₅ represents the diameter of the tip 35 near the upper end of the taper 37. In one aspect, this diameter w₃ is about 0.320″ while the diameter w₅ is about 0.380″. This permits the tip 35 to enter the distal end 214 and diameter w₄. Diameter w₄ is a pierce diameter and is about 0.312″. It is again noted that tip diameter w₃ must be larger than pierce diameter w₄ to catch the inwardly curled end 214. At the same time, tip diameter w₃ must be smaller than diameter w₁. Preferably, pierce diameter w₄ is no more than 85 percent of inner diameter w₁. Thus, where diameter w₁ is 0.385″, diameter w₄ will be approximately 0.327″, and preferably is 0.312″. This prevents the distal end 214 from immediately flaring outward rather than first flaring inward when the tip 35 is brought down into contact with the distal end 214.

It is noted here that the dimensions provided for w₁, w₂, w₃, w₄, and w₅ are merely examples. Other wall and punch tip sizes may be used. However, diameter w₄ should be no more than about 85 percent of dimension w₁ so as to keep the distal end 214 from immediately flaring out when the punch tip 35 contacts the single-flared distal end of stage 206.

FIG. 5 more clearly shows the tapered side 37 proximal to tip 35 of the reflare punch 36. The taper 37 increases in diameter away from the tip 35. Typically this taper will be very small, such as less than 5°, or even about 1°. The taper 37 may also have a shoulder 38 having an angle of approximately 30°. As the tip 35 is pushed down into the inner diameter of the wall 212, the tapered edge 37 contacts the inwardly curved distal end 214 of the wall 212, causing the distal end 214 to flare outwardly. The result is that the distal end 214 has an outer diameter larger than the outer diameter of the wall 212 proximate the fin stock 100. This produces a double flare collar 215, in one embodiment.

Returning again to FIG. 4B, it can be seen that the tip 35 has contacted the distal end 214 of the wall 212. Downward force causes the distal end 214 to fold inwardly, forming a single flare feature.

FIG. 4C shows a second flaring step 207. This is caused by further urging the reflare punch 36 into the inner diameter of the wall 212. This movement forces the distal end 214 of the wall 212 to be flared outward, meaning that the diameter of the distal end 214 is larger than the diameter of the wall 212 proximate the fin 100. Because the distal end 214 is reinforced with or formed of two layers of metal material, the probability of cracking at the distal end 214 is greatly diminished. The result is that the double flare end 214 has a larger diameter than the proximal end 211, but has a greater thickness than the single flare 114 of FIG. 1. Thus, it is believed that torque resistance of the tube within the collar 215 is improved. Moreover, testing has demonstrated that cooling efficiency from the tubing 40 into the fins 100 having the double flare collars 215 is potentially increased.

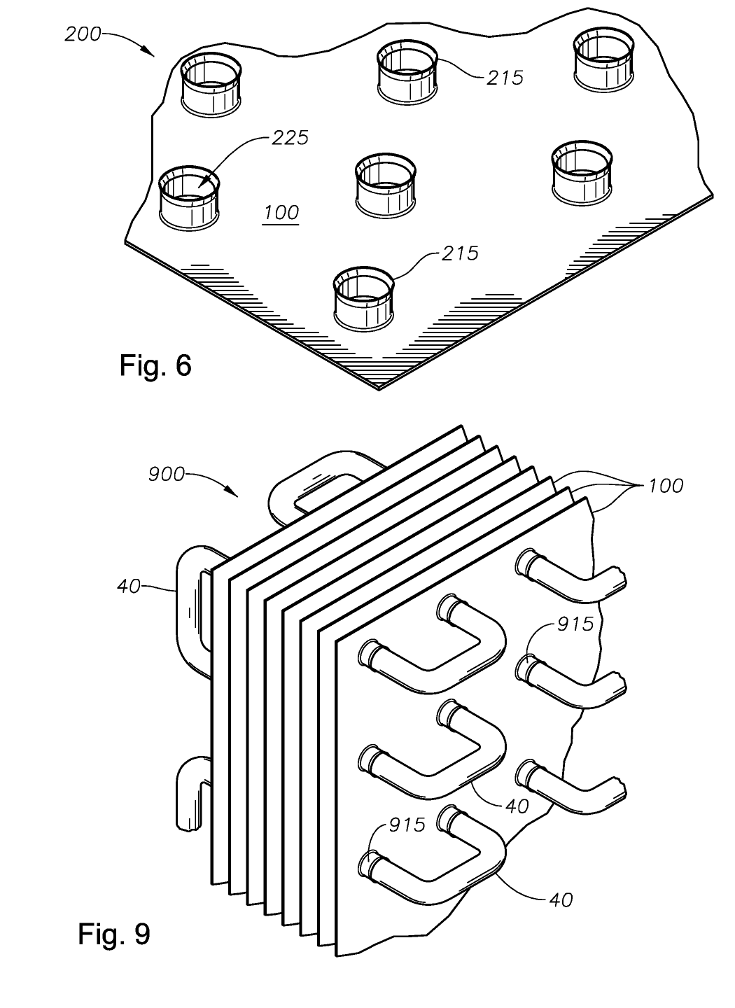

It is understood that during the metal stamping process, an array of collars 215 is formed. Each of the collars 215 defines a through-opening 225 that is sized to receive a tube (seen at 40 in FIGS. 7A and 7B) in generally transverse relation. FIG. 6 presents a portion of a plate or fin 100 having a plurality of completed double flare collars 215 in such an array. The double flare collars 215 have a circular profile. Each collar 215 is at a collar location on the plate 100.

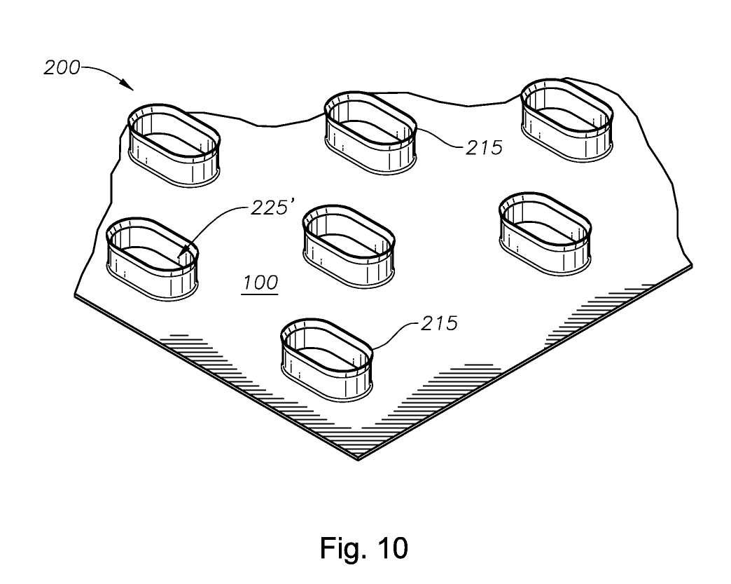

FIG. 10 presents a portion of a fin 100 also having a plurality of completed double flare collars 215′. Here, the double flare collars 215′ have an oval profile.

It is also understood that fins 100 come in many different sizes, and have different collar arrays. Oftentimes, fins are custom made according to a customer's design parameters. Therefore, the present inventions should not be limited by any fin size or collar array. Further, it is understood that that the steps for forming a collar of FIG. 2A are not exhaustive. In a typical metal-stamping operation, a die plate may utilize many progressive pressing steps before a collar 215 is fully formed.

The double flared collar 215 is preferably circular in profile, and is configured to circumferentially receive a tube in a heating or cooling unit. FIGS. 7A-7B demonstrate the formation of a portion of a single fin-tube heat exchanger 700. In FIG. 7A, the plate is again seen at 100. A collar is shown at 215 in the plate 100. The collar 215 represents a completed collar per FIG. 2. In this respect, the collar 215 includes the wall 212 and the double flared distal end 214 forming a through opening for receiving a tube. In FIG. 7A, a tube 40 has been inserted through the collar 215. However, complete frictional engagement does not yet exist between the outer diameter of the tube 40 and the collar 215.

To provide a better frictional engagement between the outer diameter of the tube 40 and the collar 215, a bearing (or expansion ball) is extruded through the length of the tube 40. In FIG. 7A, an expansion ball is shown at 45. The expansion ball 45 is at the end of the tube 40, and has not yet entered the tube 40. A single, free expansion ball is shown. However, it is known to use other bearing arrangements, such as an elongated rod having a protruding, ball-shaped tip. The ball-shaped tip may be screwed onto the end of the rod or brazed thereon using a silver (or other) solder.

In FIG. 7B, the expansion ball 45 is being urged through the tube 40 in the direction of arrow 42. It can be seen that along the portion of the tube 40 where the expansion ball 45 has passed, the inner and outer diameters of the tube 40 have been enlarged. This includes the portion of the tube 40 that intersects the collar 215. By radially expanding the tubing 40 outwardly, a frictional engagement is provided between the outer diameter of the tube 40 and the collar 215.

It is understood that in the formation of the fin-tube heat exchanger 700, a large number of plates 100 or fins having identically dimensioned and aligned collars 215 would receive the tube 40. Thus, FIGS. 7A and 7B are representative of a process that takes place simultaneously in a plurality of through-openings 215.

A method for forming collars in a thermally conductive plate is also provided herein. The method includes placing a thermally conductive plate, such as plate 100, within a press. The plate 100 is advanced through the press in order to form a plurality of through-openings 225 in the plate 100. Each through-opening defines a radial wall having a distal end 214. The plate 100 is further advanced through the press so as to form an inward flare at the distal end 214 of each of the plurality of walls 212, thereby forming double flared collars 215.

The process of forming the through-openings includes drawing metal material from the plate 100. A series of drawing steps such as steps 201-204 from FIG. 2A is employed. The process of drawing allows a volume of material to be extruded from the plate 100 in order to manipulate the material into a selected geometry prior to piercing 205. The benefit of drawing is that it affords an amount of material that can be used to fold the distal end 214 of the wall 212 inwardly to provide the first flare. The drawing process stretches the ductile metal material so as to allow a small inner diameter to be created for the collar 215 while still providing enough material to allow for a greater collar height.

It is preferred that each of the radial walls 212 of the collars 215 is substantially cylindrical. It is also preferred that the plate 100 is further advanced through the press so as to form an outward flare at the distal end 214 of each of the plurality of walls 212. In this way, “double flare” collars are provided. As noted, FIG. 6 presents a portion of a fin 100 having a plurality of completed double flare collars 215.

In one embodiment, the step of forming a plurality of circular through-openings 225 in the plate 100 comprises using a pierce punch to pierce through openings through the plate. Each through-opening 225 has a proximal end 211 integral to the plate 100 defining a first diameter w₁, and a distal end 214 defining a second smaller diameter w₄. The diameter w₄ is a result of a piercing step, such as step 205 of FIG. 4A.

After the piercing step 205, an inward flare is formed. In one aspect, the step of forming an inward flare at the distal end 214 of each of the plurality of walls 212 comprises moving a reflare punch 36 down onto the distal end 214 of each of the walls 212. The reflare punch 36 has a tip 35 with a diameter w₃ that is larger than the tip diameter w₄ of each of the walls 212. This may be in accordance with step 206 of FIG. 4B.

In one embodiment, the step of forming an outward flare at the distal end 214 of each of the plurality of walls 212 comprises further moving the reflare punch 36 downward onto the distal end 214 of the walls 212 so as to enlarge the tip diameter. This may be in accordance with step 207 of FIG. 4C. In this way, a double flare collar 215 is formed.

The through openings 225 of each of the collars 215 is dimensioned to receive an expandable metal tube 40. In a further step, such a tube 40 is inserted through at least one of the plurality of through openings 225. The tube 40 is then expanded into frictional engagement with the surrounding walls 212, as shown in FIG. 7B.

FIG. 8 presents a cross-sectional view of a double flare collar 800 of the present invention, in an alternate embodiment. Here, both flares are outward flares. The collar 800 is again extruded from fin stock 100. The collar has a side wall 812 with a proximal end 811 and a distal end 814. The distal end 814 is curled outwardly around to the outer diameter of the side wall 812, and is also flared outwardly to enlarge the diameter of the wall 812 at the distal end 814.

An improved fin-tube heat exchanger is also provided herein. FIG. 9 presents a perspective view of a portion of a fin-tube heat exchanger 900, in one embodiment. The fin-tube heat exchanger 900 includes at least one elongated tube 40. The tube 40 is configured to carry a working fluid such as Freon™. The heat exchanger 900 also includes a plurality of thermally conductive plates 100 arranged in spaced-apart and parallel relation. Each plate 100 receives a tube 40 through through-openings formed from collars 915. The collars 915 may be in accordance with collar 215 of FIG. 2 or collar 815 of FIG. 8. In this way, double flare collars are used in the improved fin-tube heat exchanger 900.

It is noted that each of the plates 100 or fins in FIG. 9 comprises a plurality of substantially cylindrical walls defining double flare collars 915 for receiving a plurality of respective tubes 40. Correlating openings in the respective plates 100 are aligned for receiving the tubes 40. The tubes 40 form a closed system for circulating Freon™ through the exchanger 900.

As can be seen, an improved collar for a fin-tube heat exchanger is offered. In addition, a method for fabricating an improved collar is offered. Finally, an improved fin-tube heat exchanger having double flare collars is provided. It is understood that the embodiments shown and described for these inventions are merely illustrative, and that other embodiments may exist within the spirit and scope of the claims, which follow.

I claim:

1. A method for forming a plurality of collars in a thermally conductive plate, comprising the steps of:
placing a thermally conductive plate within a press;
advancing the plate through the press in order to draw a desired amount of ductile material from a plurality of collar locations within the plate, said material to be used in forming the collars;
further advancing the plate in order to pierce the material at the collar locations, thereby creating a plurality of through-openings in the plate, each through-opening defining a radial wall having a distal end;
using the press so as to fold material at the distal end of the respective radial walls inwardly into substantial contact with an inner diameter of the respective walls, thereby forming a first flare in each of a plurality of collars; and
further using the press so as to expand an outer diameter of each of the walls at its respective distal end, thereby forming a second flare in each of the plurality of collars, and resulting in a plurality of double flare collars.

2. The method of claim 1, wherein each of the walls has a substantially circular profile.

3. The method of claim 1, wherein each of the walls has a substantially oval profile.

4. The method of claim 1,
wherein each of the plurality of through-openings is dimensioned to receive an expandable tube; and
further comprising the step of inserting a tube through each of the plurality of through-openings so as to expand an outer diameter of the expandable tube into frictional engagement with a surrounding wall in the respective collars.

5. The method of claim 1, wherein advancing the plate through the press in order to draw a desired amount of material from a plurality of collar locations comprises:
creating a hemisphere-shaped profile at each of the plurality of collar locations.

6. The method of claim 5, wherein advancing the plate through the press in order to draw a desired amount of material from a plurality of collar locations comprises further comprises:
manipulating the hemisphere-shaped profiles into rectangular-shaped profiles at each of the plurality of collar locations; and
manipulating the rectangular-shaped profiles into square-shaped profiles at each of the plurality of collar locations.

7. The method of claim 1, wherein using the press so as to fold material at the distal end of the respective radial walls inwardly comprises:
piercing the material at each of the plurality of collar locations with a pierce punch so as to form respective openings at a distal end of the material having a diameter w₄; and
partially lowering a reflare punch through the opening so as to contact a shoulder of the reflare punch against the distal end of the material.

8. The method of claim 7, wherein the reflare punch comprises:
the shoulder, and
a tapered tip;
and wherein:
the tapered tip narrows from a first diameter w₅ adjacent the shoulder, to a second diameter w₃;
a diameter of the shoulder is greater than first diameter w₅;
the first diameter w₅ is greater than diameter w₄ prior to partially lowering the reflare punch; and
the second diameter w₃ is less than diameter w₄.

9. The method of claim 7, wherein:
each of the walls has a proximal end integral to the plate;
each of the walls has an inner diameter w₁; and
inner diameter w₁ is greater than diameter w₄ prior to partially lowering the reflare punch.

10. A method for forming a plurality of collars in a thermally conductive plate, comprising the steps of:
placing a thermally conductive plate within a press;
advancing the plate through the press in order to draw a desired amount of ductile material from a plurality of collar locations within the plate, said material to be used in forming the collars;
further advancing the plate in order to pierce the material at the collar locations, thereby creating a plurality of circular through-openings in the plate, each through-opening defining a radial wall having a distal end;
using the press so as to form a first flare at the distal end of each of the respective walls whereby the distal end of each wall is folded inwardly into its respective wall; and
further using the press so as to form an outward flare at the distal end of each of the plurality of walls such that the outer diameter of the distal end of each wall is expanded, thereby forming a plurality of double flare collars.

11. The method of claim 10, wherein the step of forming a plurality of circular through-openings in the plate comprises using a pierce punch to pierce through-openings through the material at each of the collar locations, each through-opening having a proximal end integral to the plate having a first diameter, and a distal end having a second smaller pierce diameter.

12. The method of claim 11, wherein forming a first flare at the distal end of each of the plurality of walls comprises moving a reflare punch down onto the distal end of each of the walls, the reflare punches having a tapered tip with a diameter that is larger than the second diameter of each of the walls, thereby forming an inward flare.

13. The method of claim 12, wherein the pierce diameter is no more than 85% of the first diameter.

14. The method of claim 12, wherein the step of forming an outward flare at the distal end of each of the plurality of walls comprises further moving the reflare punch downward onto the distal end of the walls so as to enlarge the second diameter.
